(19) United States
(12) Patent Application Publication
(10) Pub. No.: US 2008/0164849 A1
(43) Pub. Date: Jul. 10, 2008

(54) Charging regime at any state of charge using the first derivative of temperature and the first and second derivative of voltage with respect to time

(75) Inventor: Christopher M. Ciaramitaro, Lapeer, MI (US)

Correspondence Address: HARNESS, DICKEY & PIERCE, P.L.C., P.O. BOX 828, BLOOMFIELD HILLS, MI, 48303, US

(73) Assignee: Cobasys LLC

(21) Appl. No.: 11/651,129

(22) Filed: Jan. 9, 2007

(51) Int. Cl. H02J 7/00; H01M 10/44

(52) U.S. Cl. 320/151; 320/161

(57) ABSTRACT

A battery control module for a rechargeable battery includes a voltage measuring module that measures a voltage of the rechargeable battery and that estimates a first derivative of the voltage with respect to time (dV/dt) and a second derivative of the voltage with respect to time (d²V/dt²). A charge control module estimates a maximum charging current based on dV/dt. A current control module limits a charging current of the rechargeable battery to the maximum charging current and turns off the charging current when d²V/dt² is greater than dV/dt.

### FIELD OF THE INVENTION

The present invention relates to determining a state of charge in a battery.

### BACKGROUND OF THE INVENTION

Battery systems may be used to provide power in a wide variety of applications. Exemplary transportation applications include hybrid electric vehicles (HEV), electric vehicles (EV), heavy duty vehicles (HDV) and vehicles with 42-volt electrical systems. Exemplary stationary applications include backup power for telecommunications systems, uninterruptible power supplies (UPS), and distributed power generation applications.

Examples of the types of batteries that are used include nickel metal hydride (NiMH) batteries, lead-acid batteries, and other types of batteries. A battery system may include a plurality of battery subpacks that are connected in series and/or in parallel. The battery subpacks may include a plurality of batteries that are connected in parallel and/or in series.

Before recharging a NiMH battery, a charging system can fully discharge the NiMH battery. Beginning the charging process with the NiMH battery in the fully discharged condition facilitates determining the state of charge as the charging system recharges the NiMH battery. For example, the charging system can charge the fully discharged NiMH battery at a predetermined current for a predetermined time to fully charge the NIMH battery. The predetermined current and time can be based on voltage, current, and/or energy limits of a selected NiMH battery. Overcharging has an undesirable effect on the NiMH batteries and there remains a need in the art for methods of charging NiMH batteries.

### SUMMARY OF THE INVENTION

A battery control module for a rechargeable battery includes a voltage measuring module that measures a voltage of the rechargeable battery and that estimates a first derivative of the voltage with respect to time (dV/dt) and a second derivative of the voltage with respect to time (d²V/dt²). A charge control module estimates a maximum charging current based on dV/dt. A current control module limits a charging current of the rechargeable battery to the maximum charging current and turns off the charging current when d²V/dt² is greater than dV/dt.

In other features the battery control module includes a temperature measuring module that measures a temperature of the battery and that estimates a first derivative of the battery temperature with respect to time (dT/dt). The current control module turns off the charging current when dT/dt is greater than a predetermined rate. The charge control module sets the maximum charging current to a predetermined value when dV/dt is greater than a first predetermined value. The charge control module sets the maximum charging current to the predetermined value divided by s when dV/dt is less than the first predetermined value, wherein the variable s is a rational number greater than 1. The charge control module sets the maximum charging current to the predetermined value divided by r when dV/dt is less than a second predetermined value. The variable r is a rational number greater than s and the first predetermined value is greater than the second predetermined value. In some embodiments r=5 and s=2. A rechargeable battery system includes the battery control module and the rechargeable battery. The rechargeable battery is a nickel metal hydride battery.

A battery control module for a rechargeable battery includes a voltage measuring module that measures a voltage of the rechargeable battery and that estimates a first derivative of the voltage with respect to time (dV/dt). A charge control module estimates a maximum charging current based on dV/dt. A temperature measuring module measures a temperature of the battery, estimates a first derivative of the battery temperature with respect to time (dT/dt), and communicates with the charge control module. A current control module limits a charging current of the rechargeable battery to the maximum charging current. The charge control module reduces the maximum charging current from an initial value while dT/dt is less than a predetermined rate and dV/dt is positive and decreasing.

In other features the current control module turns off the charging current when dT/dt is greater than a predetermined rate. The control module steps the maximum charging current down from an initial value to a first value, and down from a first value to a second value. The first value is one-half of the initial value and the second value is one-fifth of the initial value. The voltage measuring module estimates a second derivative of the voltage with respect to time (d²V/dt²). The current control module turns off the charging current when d²V/dt² is greater than dV/dt. A rechargeable battery system includes the battery control module and the rechargeable battery. The rechargeable battery is a nickel metal hydride battery.

A method of recharging a rechargeable battery includes measuring a voltage of the rechargeable battery, estimating a first derivative of the voltage with respect to time (dV/dt) and a second derivative of the voltage with respect to time (d²V/dt²), establishing a charging current limit based on dV/dt, and limiting a charging current of the rechargeable battery to the charging current limit. The charging current limit is substantially zero when d²V/dt² is greater than dV/dt.

In other features the method includes measuring a temperature of the battery, estimating a first derivative of the battery temperature with respect to time (dT/dt), and setting the charging current limit to substantially zero when dT/dt is greater than a predetermined rate. The method includes setting the charging current limit to a predetermined value when dV/dt is greater than a first predetermined value. The method includes setting the charging current limit to the predetermined value divided by s when dV/dt is less than a first predetermined value. s is a rational number greater than 1. The method includes setting the charging current limit to the predetermined value divided by r when dV/dt is less than a second predetermined value. r is a rational number greater than s and the first predetermined value is greater than the second predetermined value. In some embodiments r=5 and s=2.

A method of charging a rechargeable battery includes measuring a voltage of the rechargeable battery, estimating a first derivative of the voltage with respect to time (dV/dt), estimating a maximum charging current based on dV/dt, measuring a temperature of the battery, estimating a first derivative of the battery temperature with respect to time (dT/dt), limiting a charging current of the rechargeable battery to the maximum charging current, and reducing the maximum charging current from an initial value while dT/dt is less than a predetermined rate and dV/dt is positive and decreasing.

In other features the method includes turning off the charging current when dT/dt is greater than a predetermined rate. The method includes stepping the maximum charging current down from an initial value to a first value, and down from a first value to a second value. The first value is one-half of the initial value and the second value is one-fifth of the initial value. The method includes estimating a second derivative of the voltage with respect to time (d2V/dt2) and turning off the charging current when d2V/dt2 is greater than dV/dt.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a functional block diagram of a battery system including battery subpacks, battery control modules and a master control module;

FIG. 2 is a functional block diagram of a battery control module;

FIGS. 3A-B are graphs of exemplary battery parameters; and

FIG. 4 is a flowchart of a method for charging a battery system regardless of its state of charge.

### DETAILED DESCRIPTION OF THE PREFERRED EMBODIMENTS

The following description of the preferred embodiment(s) is merely exemplary in nature and is in no way intended to limit the invention, its application, or uses. For purposes of clarity, the same reference numbers will be used in the drawings to identify the same elements. As used herein, the term module or device refers to an application specific integrated circuit (ASIC), an electronic circuit, a processor (shared, dedicated, or group) and memory that execute one or more software or firmware programs, a combinational logic circuit, and/or other suitable components that provide the described functionality.

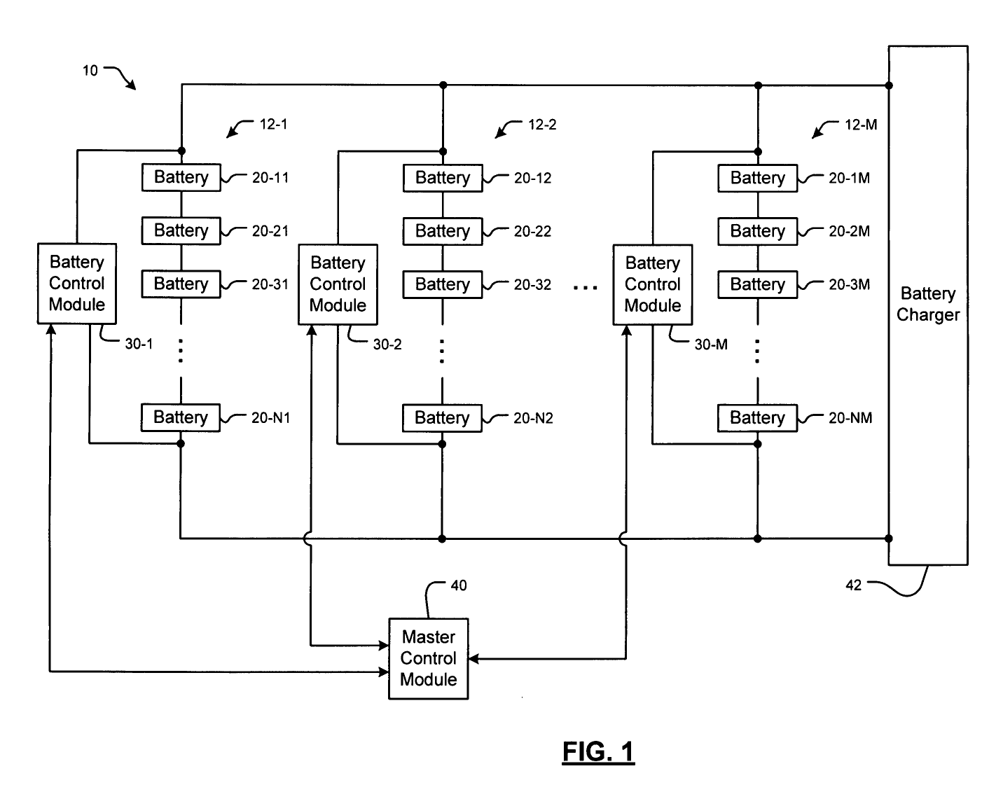

Referring now to FIG. 1, an exemplary embodiment of a battery system 10 is shown to include M battery subpacks 12-1, 12-2, . . . , and 12-M (collectively battery subpacks 12). Battery subpacks 12-1, 12-2, . . . , and 12-M include N series connected nickel-metal hydride (NiMH) batteries 20-11, 20-12, and 20-NM (collectively batteries 20). Battery control modules 30-1, 30-2, . . . and 30-M (collectively battery control modules 30) are associated with each of battery subpacks 12-1, 12-2, . . . and 12-M, respectively. In some embodiments, M is equal to 2 or 3, although additional or fewer subpacks may be used. In some embodiments, N is equal to 12-24, although additional and/or fewer batteries may be used.

Battery control modules 30 sense voltage across and current provided by battery subpacks 12. Alternatively, battery control modules 30 may monitor one or more individual batteries 20 in battery subpacks 12 and perform appropriate scaling and/or adjustments. Battery control modules 30 communicate with a master control module 40 using wireless and/or wired connections. Master control module 40 receives battery data from battery control modules 30 and generates data, such as maximum and minimum power, of battery subpack 12. In some embodiments battery control modules 30 and master control module 40 can be combined. A battery charger 42 can connect to terminals of battery system 10 and generate a charging current.

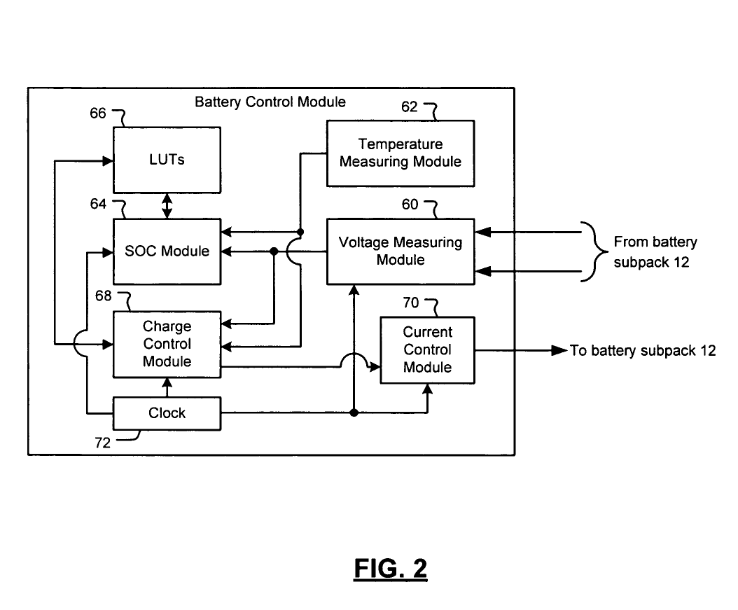

Referring now to FIG. 2, some elements are shown of each battery control module 30. Each element will be described as operating on an associated one of battery subpacks 12, however it should be appreciated that each element may also be duplicated and/or multiplexed to operate on each battery 20 of associated battery subpack 12. Similarly, the input and/or output signals of each element can operate with associated battery subpack 12 and then be scaled to represent each battery 20 of associated battery subpack 12.

Each battery control module 30 includes a voltage measuring module 60 that measures battery voltage of battery subpack 12. A battery temperature measuring module 62 measures battery temperature at least one location within battery subpack 12. A battery state of charge (SOC) module 64 determines SOC of battery subpack 12. SOC module 64 may employ one or more lookup tables 66, formulas and/or other methods to determine the SOC. A charge control module 68 employs a method that is described below to determine a maximum magnitude of charging current for battery subpack 12. A current control module 70 limits the magnitude of the charging current through battery subpack 12 based on the determination made by charge control module 68. Current control module 70 pulse-width modulates a solid state switch (not shown), such as a transistor, to limit the current flow. The solid state switch can be connected in series with the current that flows through battery subpack 12. A clock circuit 72 generates one or more clock signals for one or more of the modules that are included in battery control module 30.

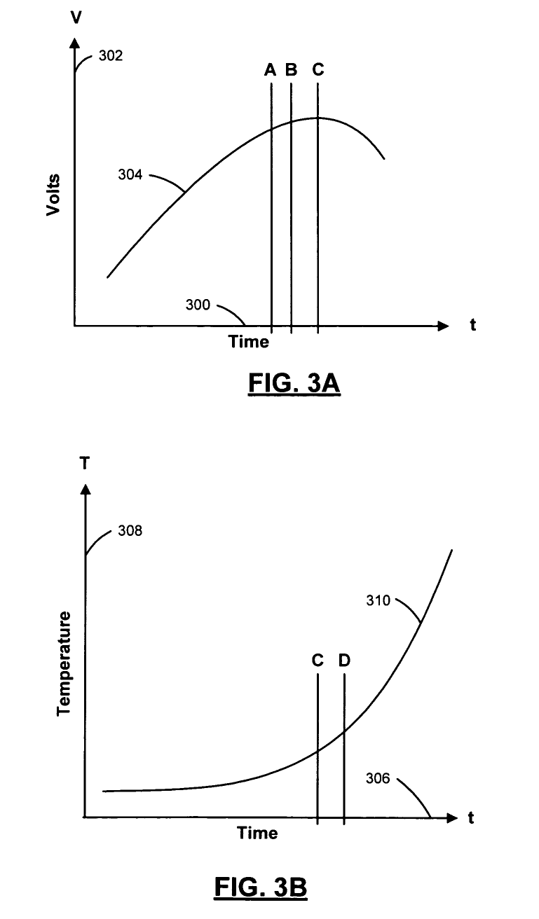

Referring now to FIG. 3A, a sample plot shows an exemplary voltage measurement with respect to time of battery voltage as a NiMH battery subpack 12 charges. A horizontal axis 300 represents time (t). A vertical axis 302 represents volts. A battery voltage trace 304 indicates the measured battery voltage (V). As the battery voltage V increases the rate of change of the battery voltage (dV/dt) decreases until battery subpack 12 is fully charged at time C. After time C dV/dt becomes negative.

The magnitudes of charging current will now be described for various times in the plot of FIG. 3A. Prior to a time A the charging current is maintained at a first predetermined current, InitialCurrent. The magnitude of InitialCurrrent can be experimentally determined and/or selected based on maximum current, voltage, and/or temperature specifications and/or application demands of battery subpack 12.

At time A the value of dV/dt becomes less than a predetermined first threshold (DV1) and thereby indicates that the charging efficiency of battery subpack 12 has decreased from when charging started. The charging current can therefore be decreased to improve the charging efficiency. At a second time B the value of dV/dt becomes less than a predetermined second threshold (DV2) and indicates that the charging efficiency has continued to reduce as the SOC of battery subpack 12 approaches 100%. At time B the charging current can be reduced again to improve the charging efficiency.

At time C battery subpack 12 is fully charged and the battery voltage V begins to decrease despite the charging current. At time C a second derivative of the battery voltage d²V/dt² is greater than the first derivative dV/dt. After time C battery subpack 12 will not accept more charge and the charging current can be turned off.

Referring now to FIG. 3B, a sample plot shows an exemplary battery temperature measurement with respect to time while battery subpack 12 charges. A horizontal axis 306 represents time t. A vertical axis 308 represents battery temperature (T) as determined by temperature measuring module 62. A trace 310 indicates the battery temperature T over time.

Battery subpack 12 is fully charged at time C and thereafter begins to overcharge. Trace 310 shows that when battery subpack 12 is being overcharged then the battery temperature T increases more rapidly than during the normal charging prior to time C. At a time D the battery temperature rate of change (dT/dt) exceeds a predetermined temperature rate DT, which indicates that the battery temperature may soon exceed a maximum battery temperature unless the charging current is turned off or substantially reduced. The maximum battery temperature may be obtained from a product data sheet for selected battery subpack 12. The predetermined temperature rate DT may also be obtained from a product data sheet for battery subpack 12 and/or experimentally determined based on the ambient temperature, heat exchange properties, minimum service life, and the like of battery subpack 12.

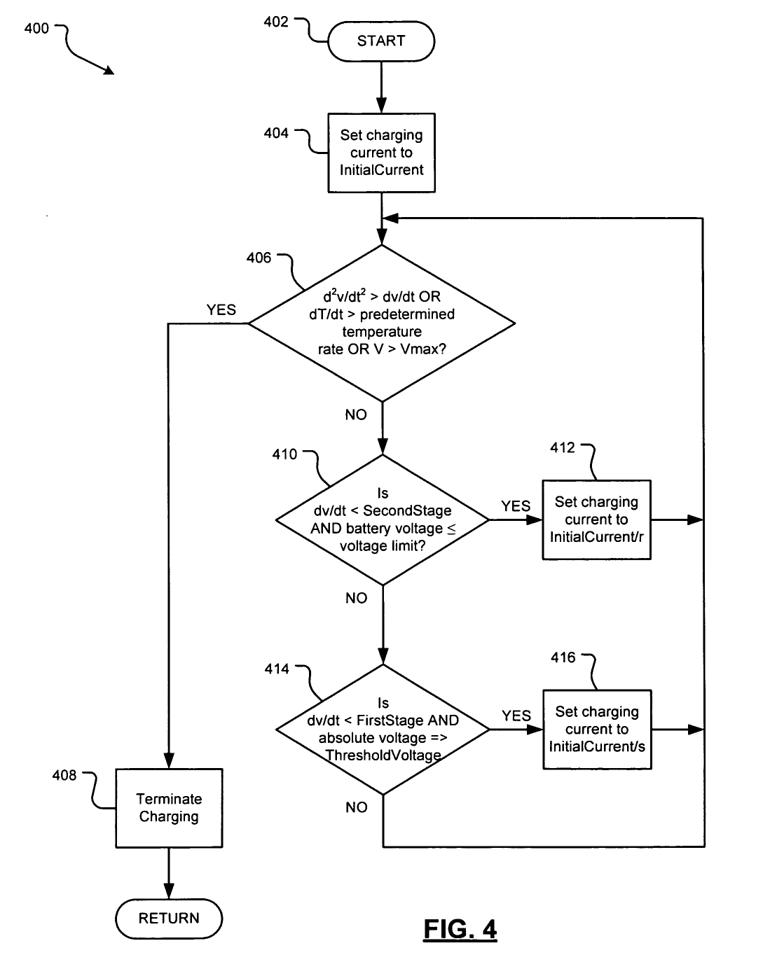

Referring now to FIG. 4, a flowchart 400 is shown of a method for charging the battery subpack 12. The method can be executed when battery subpack 12 is at any state of charge. Method 400 can be implemented as a computer program that is stored in a computer memory and executed by a computer. The computer and computer memory can be included in battery control module 30.

Control enters through start block 402 and immediately proceeds to block 404. In block 404 control limits the charging current to InitialCurrent. Control then proceeds to decision block 406 and determines whether the second derivative of the battery voltage, d²V/dt², is greater than the first derivative of the battery voltage, dV/dt, or whether the first derivative of the battery temperature, dT/dt, is greater than the predetermined rate that is shown and described with FIG. 3B, or whether the battery voltage is greater than a maximum voltage Vmax, where Vmax is a function of the battery temperature T. If any of the test results from decision block 406 are positive or true then control proceeds to block 408 and turns off the charging current. If all of the test results in decision block 406 are negative or false then control proceeds to decision block 410.

In decision block 410 control determines whether the first derivative of battery voltage dV/dt is less than the second predetermined limit DV2. If so, then control branches to block 412 and reduces the charging current. In some embodiments the method can reduce the charging current to a value of InitialCurrent/r, where r is a rational number greater than 1. In some embodiments r is equal to 5. Control returns to block 406 from block 412.

If the result is negative or false in decision block 410 then control branches from decision block 410 to decision block 414. In decision block 414 control determines whether the first derivative of battery voltage dV/dt is less than the first predetermined limit DV1. If so, then control branches to block 416 and reduces the charging current. In some embodiments the method can reduce the charging current to a value of InitialCurrent/s, where s is a rational number greater than one and less than r. In some embodiments s is equal to 2. Control returns to block 406 from block 416. If the result is negative or false in decision block 414 then control leaves the charging current unchanged and branches from decision block 414 to decision block 406.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A battery control module for a rechargeable battery, comprising:
a voltage measuring module that measures a voltage of the rechargeable battery and that estimates a first derivative of the voltage with respect to time (dV/dt) and a second derivative of the voltage with respect to time (d²V/dt²);
a charge control module that estimates a maximum charging current based on dV/dt; and
a current control module that limits a charging current of the rechargeable battery to the maximum charging current and that turns off the maximum charging current when d²V/dt² is greater than dV/dt.

2. The battery control module of claim 1 further comprising a temperature measuring module that measures a temperature of the battery and that estimates a first derivative of the battery temperature with respect to time (dT/dt), wherein the current control module turns off the charging current when dT/dt is greater than a predetermined rate.

3. The battery control module of claim 1 wherein the charge control module sets the maximum charging current to a predetermined value when dV/dt is greater than a first predetermined value.

4. The battery control module of claim 3 wherein the charge control module sets the maximum charging current to the predetermined value divided by s when dV/dt is less than the first predetermined value, wherein s is a rational number greater than 1.

5. The battery control module of claim 4 wherein the charge control module sets the maximum charging current to the predetermined value divided by r when dV/dt is less than a second predetermined value, wherein r is a rational number greater than s and the first predetermined value is greater than the second predetermined value.

6. The battery control module of claim 5 wherein r=5 and s=2.

7. A rechargeable battery system comprising the battery control module of claim 1 and the rechargeable battery.

8. The rechargeable battery system of claim 7 wherein the rechargeable battery is a nickel metal hydride battery.

9. A battery control module for a rechargeable battery, comprising:
a voltage measuring module that measures a voltage of the rechargeable battery and that estimates a first derivative of the voltage with respect to time (dV/dt);
a charge control module that estimates a maximum charging current based on dV/dt;
a temperature measuring module that measures a temperature of the battery, estimates a first derivative of the battery temperature with respect to time (dT/dt), and communicates with the charge control module; and
a current control module that limits a charging current of the rechargeable battery to the maximum charging current and that reduces the maximum charging current from an initial value while dT/dt is less than a predetermined rate and dV/dt is positive and decreasing.

10. The battery control module of claim 9 wherein the current control module sets the maximum charging current to substantially zero when dT/dt is greater than a predetermined rate.

11. The battery control module of claim 9 wherein the control module steps the maximum charging current down from an initial value to a first value, and down from a first value to a second value.

12. The battery control module of claim 11 wherein the first value is one-half of the initial value and the second value is one-fifth of the initial value.

13. The battery control module of claim 9 wherein the voltage measuring module estimates a second derivative of the voltage with respect to time (d²V/dt²) and wherein the current control module turns off the charging current when d²V/dt² is greater than dV/dt.

14. A rechargeable battery system comprising the battery control module of claim 9 and the rechargeable battery.

15. The rechargeable battery system of claim 14 wherein the rechargeable battery is a nickel metal hydride battery.

16. A method of recharging a rechargeable battery, comprising:
measuring a voltage of the rechargeable battery;
estimating a first derivative of the voltage with respect to time (dV/dt) and a second derivative of the voltage with respect to time (d²V/dt²);
establishing a charging current limit based on dV/dt;
limiting a charging current of the rechargeable battery to the charging current limit; and
turning off the charging current when d²V/dt² is greater than dV/dt.

17. The method of claim 16 further comprising:
measuring a temperature of the battery;
estimating a first derivative of the battery temperature with respect to time (dT/dt); and
turning off the charging current when dT/dt is greater than a predetermined rate.

18. The method of claim 16 further comprising setting the charging current limit to a predetermined value when dV/dt is greater than a first predetermined value.

19. The method of claim 18 further comprising setting the charging current limit to the predetermined value divided by s when dV/dt is less than a first predetermined value, wherein s is a rational number greater than 1.

20. The method of claim 19 further comprising setting the charging current limit to the predetermined value divided by r when dV/dt is less than a second predetermined value, wherein r is a rational number greater than s and the first predetermined value is greater than the second predetermined value.

21. A method of charging a rechargeable battery, comprising:
measuring a voltage of the rechargeable battery;
estimating a first derivative of the voltage with respect to time (dV/dt);
estimating a maximum charging current based on dV/dt;
measuring a temperature of the battery;
estimating a first derivative of the battery temperature with respect to time (dT/dt);
limiting a charging current of the rechargeable battery to the maximum charging current;
reducing the maximum charging current from an initial value while dT/dt is less than a predetermined rate and dV/dt is positive and decreasing.

22. The method of claim 21 further comprising turning off the charging current when dT/dt is greater than a predetermined rate.

23. The method of claim 21 further comprising stepping the maximum charging current down from an initial value to a first value, and down from a first value to a second value.

24. The method of claim 23 wherein the first value is one-half of the initial value and the second value is one-fifth of the initial value.

25. The method of claim 21 further comprising estimating a second derivative of the voltage with respect to time (d²V/dt²) and turning off the charging current when d²V/dt² is greater than dV/dt.
